(19) United States
(12) Patent Application Publication
(10) Pub. No.: US 2022/0288430 A1
(43) Pub. Date: Sep. 15, 2022

(54) FACIAL MASK MOUNTING LOOP AND STRAPLESS FACE MASK

(71) Applicants: Kathryn Kelly Olin, Golden Valley, MN (US); Paul Scott Olin, Golden Valley, MN (US)

(72) Inventors: Kathryn Kelly Olin, Golden Valley, MN (US); Paul Scott Olin, Golden Valley, MN (US)

(21) Appl. No.: 17/693,012

(22) Filed: Mar. 11, 2022

Related U.S. Application Data
(60) Provisional application No. 63/159,540, filed on Mar. 11, 2021.

(51) Int. Cl. A62B 18/08; A41D 13/11

(52) U.S. Cl. CPC A62B 18/084; A41D 13/1169

(57) ABSTRACT

A facial mask mounting loop includes a loop body forming a closed loop of material. The loop body includes a mask adhesive on a mask side configured to adhere to a facial mask, and a facial adhesive configured to adhere to a user's face on a skin side that opposes the mask side. The loop body also includes a chin portion configured to attach under a chin of the user's face using the facial adhesive, a bridge portion configured to attach over a bridge of a nose of the user's face using the facial adhesive, and a pair of expandable cheek portions each extending between the chin and bridge portions and configured to attach over a cheek of the user's face using the facial adhesive. The expandable cheek portions expand and contract in response to facial movements of the user.

### CROSS-REFERENCE TO RELATED APPLICATION

The present application is based on and claims the benefit of U.S. provisional patent application Ser. No. 63/159,540, filed Mar. 11, 2021, the content of which is hereby incorporated by reference in its entirety.

### BACKGROUND

Face masks, such as surgical masks and cloth masks are worn over the mouth and nose of a user as a health control measure to prevent the spread of infections, such as to limit the transmission of infections from the wearer and, in some instances, provide protection to the wearer from an airborne contagion.

Such masks may be re-usable or disposable, and typically include ear loops for attaching the mask to a user's face. Such ear loops can be problematic, such as when the user is wearing glasses or dangly earrings, or while getting a haircut.

### SUMMARY

Embodiments of the present disclosure relate to a facial mask mounting loop that facilitates attachment of a facial mask to a user's face without the need for ear loops or straps, a strapless facial mask that includes the facial mask mounting loop, and a method of attaching a facial mask to a user's face using the facial mask mounting loop.

One embodiment of the facial mask mounting loop includes a loop body forming a closed loop of material. The loop body includes a mask adhesive on a mask side configured to adhere to a facial mask, and a facial adhesive configured to adhere to a user's face on a skin side that opposes the mask side. The loop body also includes a chin portion configured to attach under a chin of the user's face using the facial adhesive, a bridge portion configured to attach over a bridge of a nose of the user's face using the facial adhesive, and a pair of expandable cheek portions each extending between the chin and bridge portions and configured to attach over a cheek of the user's face using the facial adhesive. When the facial adhesive is attached to the face of a user, the expandable cheek portions expand and contract in response to facial movements of the user.

One embodiment of the strapless facial mask includes a facial mask configured to cover and surround a nose and mouth of the user's face, and a mounting loop attached to the facial mask. The facial mask includes a bridge portion configured to extend across a bridge of the nose of the user's face, opposing cheek portions, each configured to extend across a cheek of the user's face, and a chin portion configured to extend across a chin of the user's face. The mounting loop includes a loop body forming a closed loop of material. The loop body includes a mask adhesive on a mask side attached to an interior surface of the facial mask, a facial adhesive on a skin side that opposes the mask side, the facial adhesive configured to adhere to the user's face, a chin portion aligned with the chin portion of the facial mask and configured to attach under the chin of the user's face using the facial adhesive, a bridge portion aligned with the bridge portion of the facial mask and configured to attach over the bridge of the nose of the user's face using the facial adhesive, and a pair of expandable cheek portions extending between the chin and bridge portions of the loop body, each expandable cheek portion is aligned with one of the cheek portions of the facial mask and configured to attach over the cheek of the user's face using the facial adhesive. When the facial adhesive is attached to the face of a user, the expandable cheek portions expand and contract in response to facial movements of the user.

In one embodiment of the method, a facial mask is provided that is configured to cover and surround a nose and mouth of the user's face. The facial mask includes a bridge portion, opposing cheek portions, and a chin portion. A mounting loop including a loop body forming a closed loop of material is also provided. The loop body includes a mask adhesive on a mask side, a facial adhesive on a skin side that opposes the mask side, a chin portion, a bridge portion, and a pair of expandable cheek portions extending between the chin and bridge portions of the loop body. The loop body is attached to an interior surface of the facial mask using the mask adhesive. The bridge portion of the loop body is aligned with the bridge portion of the facial mask, the expandable cheek portions of the loop body are each aligned with one of the cheek portions of the facial mask, and the chin portion of the loop body is aligned with the chin portion of the facial mask. The loop body and the facial mask are attached to the user's face using the facial adhesive such that the bridge portion of the loop body is attached to the bridge of the nose of the user's face using the facial adhesive, the expandable cheek portions of the loop body are attached to one of the cheeks of the user's face using the facial adhesive, and the chin portion of the loop body is attached to the chin of the user's face using the facial adhesive. The expandable cheek portions expand and contract in response to facial movements of the user.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the Background.

### BRIEF DESCRIPTION OF THE DRAWINGS

FIG. 1 is a simplified diagram illustrating a face mask attached to a user's face using a mask adhesive, in accordance with embodiments of the present disclosure.

FIG. 2 is a simplified drawing illustrating the mask adhesive attached to the user's face without the mask being present.

FIG. 3 is a simplified side cross-sectional view of a portion of the mask adhesive, in accordance with embodiments of the present disclosure.

FIG. 4 is a simplified side cross-sectional view of a portion of the mask adhesive attached to a mask, in accordance with embodiments of the present disclosure.

FIGS. 5 and 6 are simplified diagrams respectively illustrating varying thicknesses and widths of the mask adhesive, in accordance with embodiments of the present disclosure.

FIG. 7 illustrates contracted and expanded states of an expandable portion of the mask adhesive, in accordance with embodiments of the present disclosure.

FIG. 8 is a simplified front view of a portion of a facial mask, in accordance with embodiments of the present disclosure.

### DETAILED DESCRIPTION OF ILLUSTRATIVE EMBODIMENTS

Embodiments of the present disclosure are described more fully hereinafter with reference to the accompanying drawings. Elements that are identified using the same or similar reference characters refer to the same or similar elements. The various embodiments of the present disclosure may, however, be embodied in many different forms and should not be construed as limited to the embodiments set forth herein. Rather, these embodiments are provided so that this disclosure will be thorough and complete, and will fully convey the scope of the present disclosure to those skilled in the art.

Embodiments of the present disclosure relate to a facial mask mounting loop for attaching a facial mask to a user's face without the need for ear loops or other straps (e.g., head or neck straps), and a face mask that includes the facial mask mounting loop.

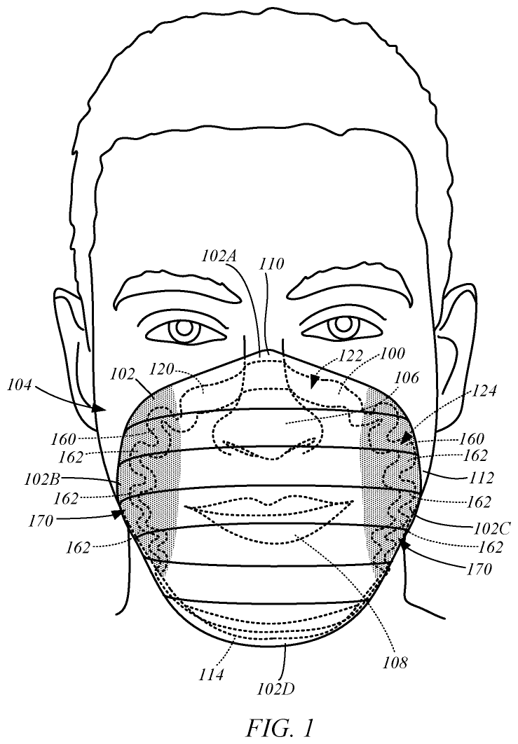

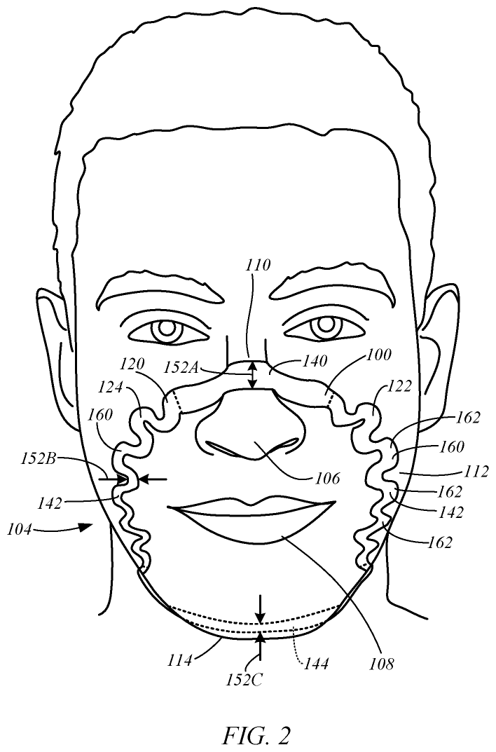

Examples of a facial mask mounting loop 100 and a face mask 102 in accordance with embodiments of the present disclosure are illustrated in FIGS. 1 and 2. FIG. 1 is a simplified diagram illustrating the face mask 102 attached to a user's face 104 using the mounting loop 100, and FIG. 2 is a simplified drawing illustrating the mounting loop 100 attached to the user's face without the mask being present.

As shown in FIG. 1, the mask 102 may be a conventional mask (e.g., N95 mask, cloth mask, etc.) that is configured to surround the nose 106 and mouth 108 of the user. Accordingly, the mask 102 includes a bridge portion 102A that is configured to extend across a bridge 110 of the user's nose 106, opposing cheek portions 102B and 102C, each of which is configured to extend across one of the user's cheeks 112, and a chin portion 102D that may extend below the chin 114 of the user.

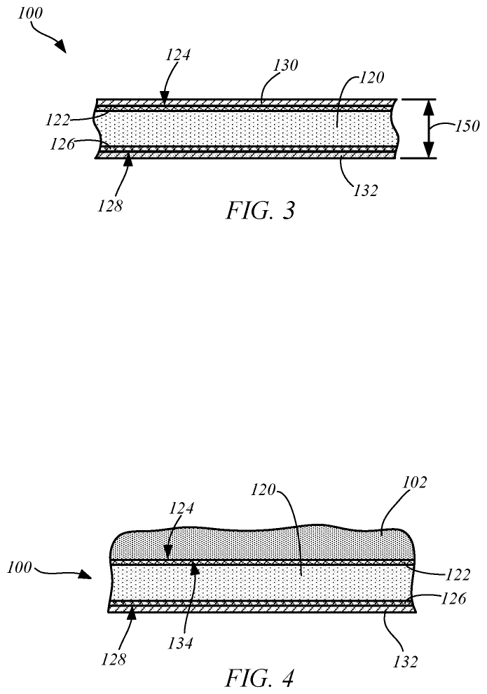

The facial mask mounting loop 100 includes a loop body 120 that is configured to attach to the skin and/or facial hair of the user's face 104, to secure the mask 102 to the user's face 104, as shown in FIG. 1. As shown in the simplified side cross-sectional view of the loop body 120 shown in FIG. 3, the loop body 120 includes mask adhesive 122 on a mask side 124 that is configured to attach to an interior side of the mask 102, such as along the perimeter of the mask 102, and a facial adhesive 126 on a skin side 128, which is opposite the mask side 124, that configured to attach to the face 104 of the user.

In some embodiments, the loop body 120 is formed of a malleable material and is sufficiently thick to conform to both the contours of the interior of the mask 102 and the user's face 104 to eliminate small gaps that would otherwise form if the mask 102 was held in place by straps or ear loops.

One advantage to using the mounting loop 100 for attaching a face mask 102 to a user's face 104 is the improved seal that may be formed therebetween. For example, masks 102, such as N95 masks, must be fit to the user to ensure a proper seal between the mask 102 and the user's face 104. When such masks are attached to a user's face using conventional straps and/or ear loops, it can be difficult to achieve the desired seal. Thus, users must undergo fit tests to match the user to a properly sized mask to promote a suitable seal. However, even when properly fit, gaps may form between the conventional mask and the user's skin due to an imperfect match between the contours of user's facial features and the perimeter of the mask. Additionally, gaps may form during periods of facial movement, such as when the user is speaking or when the mask slips relative to the user's face.

The mounting loop 100 operates to reduce or eliminate these issues. For example, the mounting loop 100 forms a seal with the interior wall of the mask 102 and a seal with the user's face 104 using the conformable structure of the loop body 120 and the adhesives 122 and 126. Since the mounting loop 100 provides the desired seals even when using masks 102 that would not fit properly when attached with ear loops or straps, the mounting loop 100 simplifies the mask fitting process. Furthermore, the seals formed by embodiments of the mounting loop 100 are less prone to disruption during normal facial movements, such as while speaking. Additionally, the adhesion between the mask 102 and the user's face 104 facilitated by the mounting loop 100 renders the mask less prone to slippage.

The mounting loop 100 may be provided separately from the facial mask 102, allowing users to apply the mounting loop 100 to a mask 102 of their choice. In this case, the mounting loop 100 may comprise a low adhesion backing or liner 130 on the mask adhesive 122 of the mask side 124, and a low adhesion backing or liner 132 on the facial adhesive 126 of the skin side 128 of the loop body 120, as shown in FIG. 3.

The mask side liner 130 may be peeled off to apply the loop body 120 to a mask 102, and the skin side liner 132 may be peeled off to prepare the mask 102 for attachment to a user's face. After detaching the mask 102 from the user's face, the loop body 120 of the mounting loop 100 may remain attached to the mask 102. One may reapply a skin side liner 132 to preserve the adhesive properties of the facial adhesive 126 for future use.

Embodiments of the present disclosure also include a facial mask that includes the mounting loop 100. Here, the mask adhesive 122 on the mask side 124 is attached to an interior side 134 of the mask 102, as illustrated in the simplified side cross-sectional view of FIG. 4. In this case, the mask 102 with the attached mounting loop 100 may include the skin side low adhesion backing or liner 132 attached to the skin side 128 of the loop body 120. Thus, one may peel off the skin side liner 132 to prepare the mask 102 for attachment to a user's face 104. As discussed above, the mask 102 with the attached mounting loop 100 may be reused, and the adhesive properties of the skin side 128 may be preserved by covering it with a skin side liner 132.

The facial adhesive 126 is preferably hypoallergenic and may take on any suitable form. In some examples, the facial adhesive 126 may comprise a silicone adhesive, a hydrogel, a medical grade adhesive, and/or another suitable adhesive.

The mask adhesive 122 may use the same type of adhesive as the facial adhesive 126, or a different type of adhesive. In some embodiments, the mask adhesive 122 is configured for adhering to conventional mask materials, such as clothing adhesive of clothing tape.

In some embodiments, the loop body 120 of the mounting loop 100 includes a bridge portion 140 that is configured to extend over the bridge 110 of the user's nose 106, cheek portions 142 that are connected to the bridge portion 140 and are configured to extend over the cheeks 112 of the user's face 104, and a chin portion 144 that is attached to the cheek portions 142 and is configured to extend under the chin 114 of the user's face 104. These features of the mounting loop 100 are generally illustrated in FIG. 2.

Embodiments of the present disclosure include a method of using the facial mask mounting loop 100 to attach a mask 102 to a user's face 104, such as shown in FIG. 1. Here, the loop body 120 may initially be attached to the interior of the facial mask 102 using the mask adhesive 122 such that the bridge portion 140 is aligned with the bridge portion 102A of the facial mask 102, the cheek portions 142 are aligned with corresponding cheek portions 102B and 102C of the facial mask, and the chin portion 144 is aligned with the chin portion 102D of the facial mask 102, as shown in FIG. 1. The mask 102 may then be attached to the user's face 104 as shown in FIG. 1 using the facial adhesive 126 of the loop body 120. One alternative to this method involves attaching the loop body 120 to the user's face 104 using the facial adhesive 126, then attaching the mask 102 to the loop body 120 using the mask adhesive 122.

In some embodiments, the bridge portion 140, the cheek portions 142 and the chin portion 144 of the mounting loop 100 may have different properties. For example, a thickness 150, which is measured from the mask side 124 to the skin side 128 (FIG. 3), may vary between the portions 140, 142 and 144. Thus, the thickness of the loop body 120 may be non-uniform.

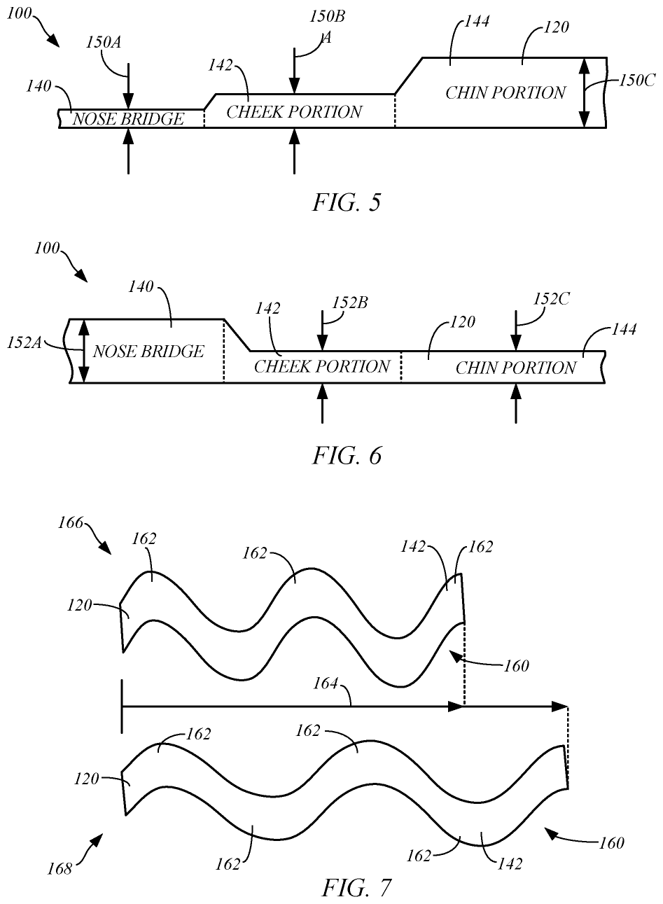

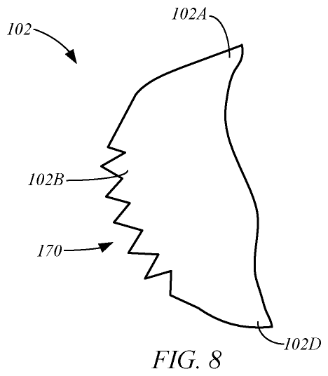

In one embodiment, the bridge portion 140 has a thickness 150A that is less than a thickness 150B of the cheek portion 142 and a thickness 150C of the chin portion 144, as illustrated schematically in FIG. 5. This takes advantage of the bridge portion 140 not having to adhere to facial hair, and due to the skin to which the bridge portion attaches not being subject to significant movements. The thin bridge portion 140 allows the mask 102 over the bridge 110 to be maintained in close proximity to the user's skin, thereby reducing vision or sight interference that would occur with the use of a thicker adhesive for the bridge portion 140.

In some embodiments, the chin portion 144 of the loop body 120 is formed thicker than the bridge portion 140 and the cheek portions 142, as indicated in FIG. 5. This can assist the chin portion 144 to adhere to facial hair and may provide cushioning for greater user comfort. Additionally, the thicker chin portion 144 may ensure a good seal between the skin side 128 of the loop body 120 and the user's skin during mandibular movements that occur while speaking.

In one example, the thickness 150A of the bridge portion 140 may be approximately 2-3 mm over the bridge 110 of the nose. The thickness 150B of the cheek portions 142 may be approximately 3-4 mm, and the thickness 150C of the chin portion 144 may be approximately 4-6 mm.

In some embodiments, a width 152 of the loop body 120, which is the narrowest distance across the mask side 124 or the skin side 128, such as shown in FIG. 2, may vary between the bridge portion 140, the cheek portions 142 and the chin portion 144. In one embodiment, the bridge portion 140 has a width 152A that is greater than a width 152B of the cheek portions 142 and/or a width 152C of the chin portion 144, as illustrated schematically in FIG. 6. This provides the benefit of increasing the seal formed between the skin side 124 of the loop body 120 and the user's skin, as well as the seal between the mask side 124 of the loop body 120 and the interior surface 134 (FIG. 4) of the mask 102. Additionally, the wider bridge portion 140 allows the loop body 120 to accommodate a wide range of different nose sizes and shapes.

In one example, the width 152A of the bridge portion 140 may be approximately 1-3 mm, the width 152B of the check portions 142 may be approximately 2-4 mm, and the width 152C of the chin portion 144 may be approximately 1-3 mm.

When a conventional mask is properly fit to a user, the straps and/or ear loops of the mask must press the mask against the user's cheeks and chin to ensure that a reasonable seal is maintained between the mask and the user's face while the user speaks. The pressure of the mask on the user's face can cause discomfort over time.

In some embodiments, the mounting loop 100 includes features that maintain a seal between the mask 102 and the user's face 104 while speaking and without applying the pressure of conventional masks. In one embodiment, each of the cheek portions 142 of the loop body 120 includes an expandable portion 160 having an accordion pattern, as shown in FIG. 2. The accordion pattern comprises a plurality of lobes 162 that accommodate lengthwise expansion and contraction of the loop body 120 at the cheek portions 142. Thus, the accordion pattern allows a length 164 of the portion 160 to stretch and contract along with the skin of the user between a contracted state 166 and an extended state 168, as illustrated in the simplified diagram of the expandable portion shown in FIG. 7. Accordingly, the expandable portions 160 operate to accommodate the protrusion of the mandible and mastication movements of the user that may occur while speaking, smiling, laughing, etc., while maintaining the attachment of the mask 102 to the user's face 104 and the desired seal between the mask 102 and the user's face 104.

In addition to the advantages mentioned above, the expandable portions 160 also allow the loop body 120 to accommodate differently sized masks, as well as different facial contours.

Embodiments of the facial mask 102 may include features that correspond to the expandable cheek portions 160 of the loop body 120. In one embodiment, the facial mask 102 includes expandable sections 170 (shaded region) to which the expandable portions 160 of the mounting loop 100 attach, as illustrated in FIG. 1. The expandable sections 170 of the facial mask 102 operate to maintain adhesion to the expandable portions 160 during movement of the expandable portions 160, such as in response to user movements (e.g., talking, smiling, etc.). This assists in maintaining the seal between the facial mask 102 and the loop body 120, which in turn assists in maintaining the seal between the mask 102 and the user's face 104 during facial movements.

The expandable sections 170 of the facial mask 102 may take on any suitable form. In one example, the expandable sections 170 include an elastic material that forms at least a portion of the facial mask 102, as indicated in FIG. 1. As the expandable portion 160 of the loop body 120 stretches and contracts in response to user movements, the elastic material of the expandable sections 170, to which the mask adhesive 122 is attached, correspondingly expands and contracts. The elastic material may include spandex, neoprene, or another suitable elastic or stretchable material.

In another example, the material forming the expandable sections 170 of the facial mask 102 may include an accordion pattern of the material forming the mask 102, as shown in the simplified front view of a portion of a facial mask 102, in accordance with embodiments of the present disclosure. The accordion patterned expandable section 170 generally operates in the manner of the expandable portions 160 of the loop body 120 discussed above. The accordion patterned expandable section 170 of the mask 102 may include a pleated section of the material forming the mask 102, or another suitable configuration.

Although the embodiments of the present disclosure have been described with reference to preferred embodiments, workers skilled in the art will recognize that changes may be made in form and detail without departing from the spirit and scope of the present disclosure.

What is claimed is:

1. A facial mask mounting loop for attaching a strapless facial mask to a user's face, the facial mask mounting loop comprising a loop body forming a closed loop of material, the loop body including:
a mask adhesive on a mask side configured to adhere to a facial mask;
a facial adhesive on a skin side that opposes the mask side, the facial adhesive configured to adhere to a user's face;
a chin portion configured to attach under a chin of the user's face using the facial adhesive;
a bridge portion configured to attach over a bridge of a nose of the user's face using the facial adhesive; and
a pair of expandable cheek portions each extending between the chin and bridge portions and configured to attach over a cheek of the user's face using the facial adhesive,
wherein, when the facial adhesive is attached to the face of a user, the expandable cheek portions expand and contract in response to facial movements of the user.

2. The facial mask mounting loop of claim 1, wherein the expandable cheek portions of the loop body comprise an accordion pattern having a plurality of lobes, which accommodate lengthwise expansion and contraction of the loop body.

3. The facial mask mounting loop of claim 1, including a first removable low adhesion backing layer on the mask adhesive.

4. The facial mask mounting loop of claim 3, including a second removable low adhesion backing layer on the facial adhesive.

5. The facial mask mounting loop of claim 1, wherein a thickness of the loop body, which is measured from the skin side to the mask side, is non-uniform.

6. The facial mask mounting loop of claim 5, wherein the thickness of the bridge portion is less than the thickness of cheek portions and/or the chin portion.

7. The facial mask mounting loop of claim 5, wherein the thickness of the chin portion is greater than the thickness of the bridge portion and/or the cheek portions.

8. The facial mask mounting loop of claim 5, wherein a width of the loop body, measured as the narrowest distance across the skin side or the mask side, is non-uniform.

9. The facial mask mounting loop of claim 8, wherein the width of the bridge portion is greater than the width of the cheek portions and/or the chin portion.

10. A strapless facial mask for covering a user's face comprising:
a facial mask configured to cover and surround a nose and mouth of the user's face, the facial mask including:
a bridge portion configured to extend across a bridge of the nose of the user's face;
opposing cheek portions, each configured to extend across a cheek of the user's face; and
a chin portion configured to extend across a chin of the user's face;
a mounting loop attached to the facial mask, the mounting loop comprising a loop body forming a closed loop of material, the loop body including:
a mask adhesive on a mask side attached to an interior surface of the facial mask;
a facial adhesive on a skin side that opposes the mask side, the facial adhesive configured to adhere to the user's face;
a chin portion aligned with the chin portion of the facial mask and configured to attach under the chin of the user's face using the facial adhesive;
a bridge portion aligned with the bridge portion of the facial mask and configured to attach over the bridge of the nose of the user's face using the facial adhesive; and
a pair of expandable cheek portions extending between the chin and bridge portions of the loop body, each expandable cheek portion aligned with one of the cheek portions of the facial mask and configured to attach over the cheek of the user's face using the facial adhesive;
expanding and contracting the expandable cheek portions in response to facial movements of the user.

11. The strapless facial mask of claim 10, wherein the expandable cheek portions of the loop body comprise an accordion pattern having a plurality of lobes, which accommodate lengthwise expansion and contraction of the loop body.

12. The strapless facial mask of claim 11, wherein the cheek portions of the facial mask include expandable sections attached to the expandable cheek portions of the loop body, the expandable sections configured to expand and contract with expansion and contraction of the expandable cheek portions.

13. The strapless facial mask of claim 10, including a removable low adhesion backing layer on the facial adhesive.

14. The strapless facial mask of claim 10, wherein a thickness of the loop body, which is measured from the skin side to the mask side, is non-uniform.

15. The strapless facial mask of claim 14, wherein the thickness of the bridge portion is less than the thickness of cheek portions and/or the chin portion.

16. The strapless facial mask of claim 14, wherein a width of the loop body, measured as the narrowest distance across the skin side or the mask side, is non-uniform.

17. The strapless facial mask of claim 16, wherein the width of the bridge portion is greater than the width of the cheek portions and/or the chin portion.

18. A method of attaching a facial mask to a user's face comprising:
providing a facial mask configured to cover and surround a nose and mouth of the user's face, the facial mask including:
a bridge portion;
opposing cheek portions; and
a chin portion;
providing a mounting loop including a loop body forming a closed loop of material, the loop body comprising:
a mask adhesive on a mask side;
a facial adhesive on a skin side that opposes the mask side;
a chin portion;
a bridge portion; and
a pair of expandable cheek portions extending between the chin and bridge portions of the loop body;
attaching the loop body to an interior surface of the facial mask using the mask adhesive, wherein:
the bridge portion of the loop body is aligned with the bridge portion of the facial mask;
the expandable cheek portions of the loop body are each aligned with one of the cheek portions of the facial mask; and
the chin portion of the loop body is aligned with the chin portion of the facial mask; and
attaching the loop body and the facial mask to the user's face using the facial adhesive, wherein:
the bridge portion of the loop body is attached to the bridge of the nose of the user's face using the facial adhesive;
the expandable cheek portions of the loop body are attached to one of the cheeks of the user's face using the facial adhesive; and
the chin portion of the loop body is attached to the chin of the user's face using the facial adhesive,
wherein the expandable cheek portions expand and contract in response to facial movements of the user.

19. The method of claim 18, wherein the expandable cheek portions of the loop body comprise an accordion pattern having a plurality of lobes, which accommodate lengthwise expansion and contraction of the loop body.

20. The method of claim 19, wherein the cheek portions of the facial mask include expandable sections attached to the expandable cheek portions of the loop body, the expandable sections configured to expand and contract with expansion and contraction of the expandable cheek portions.
